(19) United States
(12) Patent Application Publication
(10) Pub. No.: US 2026/0342056 A1
(43) Pub. Date: Oct. 29, 2026

(54) Quick and Simple Emergency Disconnection of a Stuck Medium Voltage Draw-out Circuit Breaker from its Switchgear Cubicle

(71) Applicant: National Breaker Services, LLC, Middlebury, CT (US)

(72) Inventor: Bruce Hack, Bronx, NY (US)

(73) Assignee: National Breaker Services, LLC, Middlebury, CT (US)

(21) Appl. No.: 19/187,603

(22) Filed: Apr. 23, 2025

(51) Int. Cl. H02B 11/02

(52) U.S. Cl. CPC H02B 11/02

(57) ABSTRACT

A quick and easy mechanism for removal of a circuit breaker carriage from the enclosure of a switchgear having a spacer tube secured over the longitudinal rod allowing for the racking in and out of the carriage by cooperation of the distal threads of the rod and a stationary nut at the base of the enclosure. The spacer tube is secured between the fixing channels of the carriage by a “shark” fin extending circumferentially and laterally beyond and held within a pair of opposed openings of a slot in the end of the longitudinal rod. The shark fin ensures against lateral movement of the spacer tube if in place but allows for sliding movement of the spacer tube over the longitudinal rod if the “shark” fin is removed.

### BACKGROUND OF THE INVENTION

The present invention and disclosure relates to a mechanism for quickly and easily disconnecting and allowing for an easy removal of a stuck medium voltage draw-out circuit breaker from its switchgear cabinet or enclosure. These medium voltage switchgear circuit breaker devices are normally large and supported by wheels which ride upon parallel tracks located on the bottom and within the housing, a large cabinet or enclosure. It is often necessary for repair, replacement and maintenance to remove the circuit breaker from its switchgear cabinet or enclosure. On rare occasion due to unforeseen misfortunes – a circuit breaker might get stuck within its switchgear enclosure such that the racking mechanism is not capable of removing it from the switchgear cubicle. Such a precarious situation is extremely dangerous to both the equipment and any personnel in the near environs. To be able to effect such a removal without the benefit of a working racking mechanism and to do this quickly and easily is the goal of the present invention. Generally, the switchgear’s circuit breaker is racked into the housing by use of a large and long threaded screw rod which is rotatively secured into a stationary nut which is secured within the back and on the bottom of the enclosure or cabinet. When the longitudinal rod or screw is rotated in a first clockwise direction, the circuit breaker will be drawn into the cabinet. When the rod/screw is turned in the opposite direction, the circuit breaker is (with)drawn out or removed from the enclosure or cabinet. This is the standard manner of interacting the circuit breaker with its switchgear (ie within the cabinet) and drawing the same out, when and as needed. The distal end of the longitudinal rod is threaded and captured by the stationary nut. Often the proximal end of this large and long longitudinal rod or screw is a simple hand mechanical crank. Often, the proximal head of the rod or longitudinal screw is provided with some female-shape (like a Phillips head screw, an Allen head or a simple slotted screw) and the operator can use an electric drill with the corresponding male bit to drive and turn the rod/screw for installing the switchgear into the cabinet or removing the same.

In the past, the installing (racking in) and drawing out (racking out) has been done with a longitudinal screw or rod with a distal threaded end, which rod extends distally from the front and often bottom of the switchgear towards the rear of the housing or enclosure. There it is captured by an internally threaded and stationary nut. The rod or longitudinal screw is then turned (by hand rotating, use of a crank, or an electric drill-like device) turning the head of the longitudinal rod or screw so that it couples and uncouples from the stationary internally threaded nut located at the bottom and back of the floor of the cabinet or enclosure. Turning of the head of that longitudinal rod or screw will install (rack in) the electrical circuit breaker device into the switchgear into and towards the back of the cabinet while turning that same rod or screw in the opposite direction will rack out the circuit breaker from the switchgear cabinet, housing or enclosure.

However, sometimes, the technician cannot easily back or rack out the switchgear and, indeed, on occasion, the turning of the screw first proceeds in the wrong direction so that major and financially consequential damage occurs to the switchgear and the cabinet. This, of course, is a result to be avoided. Sometimes cross threading of the rod and the stationery nut occurs. This, too, prevents easy removal of the switchgear from the enclosure. And, in any event, a quick, simple, and uncomplicated mechanism for allowing for quick racking out of the switchgear from its cabinet or housing is highly desirable. The present invention provides a simple, quick, inexpensive mechanism for removing an unintendedly stuck circuit breaker out of its switchgear enclosure or cabinet or housing and doing so still such that removal is through the front of the enclosure.

### DESCRIPTION OF THE PRIOR ART

The present invention relates to medium voltage switchgear and the quick and easy removal (or drawing out) of that switchgear’s circuit breaker from its cabinet, housing or enclosure (hereinafter collectively, for ease of reading, often referred to as the “enclosure”) when an unforeseen stuck/jammed condition exists and the normal racking mechanism of the circuit breaker will no longer properly function. Using the present invention will quickly decouple the circuit breaker from its switchgear enclosure and allow the same to be easily glided and pulled out as the wheels supporting the carriage of the circuit breaker roll over the parallel tracks on the bottom of the enclosure or the bottom itself. For a complete understanding of the present invention and its environment, the reader is directed to any one of several US Patents owned by the same Assignee as the present invention.

US Patent No. 11,444,439 issued Sep. 13, 2022, entitled: Mechanism for Limiting Racking in Circuit Breaker into Case is highly relevant, here. It shows the housing, cabinet or enclosure, the switchgear or circuit breaker and the supporting wheels on a pair of parallel tracks for facilitating removal of the electrical switchgear’s circuit breaker from the cabinet, case or enclosure. Extending crosswise from the tracks are usually a pair of parallel struts which provide support for the weight of the carriage holding the electrical components. That US Patent also shows the pair of parallel tracks on the floor of the cabinet. From time to time, it is desirable to be able to remove the switchgear’s circuit breaker and, yet, the mechanical operation of the thread of the longitudinal rod or screw may be cross threaded or otherwise inoperable with respect to the stationary nut at the bottom and rear of the cabinet. The present invention allows for the removal of the electrical switchgear’s circuit breaker from the housing or cabinet such that it can be inserted or installed into another cabinet or back into the first cabinet after repair, maintenance, or update. The present invention is a quick, simple mechanism allowing for the removal of medium voltage switchgear’s circuit breaker held in a housing or enclosure by the mechanical cooperation of the forwardly portion of a rod being threaded and cooperating with a stationary, rear located nut of the housing or enclosure.

The present invention relates to a simple, efficient and quick mechanism for allowing the quick and easy removal of the switchgear’s draw-out electrical circuit breaker and components from its cabinet, enclosure or housing. These are not the well-known circuit breakers of residential home use nor modest size, but, rather, these are generally found and used in factories and/or by municipalities where large electrical Mains (high voltage and/or current) are employed and carrying very large voltage cables. Generally, these removable circuit breakers in their large cabinetry are also referred to as switchgear and in connection with the present application and invention, the circuit breaker is racked into and out of a large compartment, enclosure, housing or cabinet by traveling upon a set of wheels which ride upon the floor of the cabinet or upon a pair of parallel tracks for supporting and guiding of the wheels out of through the front of the housing or enclosure. The wheels are rotatively secured beneath the circuit breaker on a carriage (sometimes also known as a trolley) and the tracks are secured to the bottom floor of the cabinet or enclosure. The machine operator, when required, will first ensure that the current flow and voltage of the Mains are ”off” or terminated (for obvious safety purposes) and, then, when desired, for maintenance or another reason, will remove the electrical circuit breaker component, from the cabinet, for required maintenance and/or repair.

In today’s more modern switchgear, a handle is provided to the front face of the circuit breaker and it can be used by the operator to pull the switchgear or circuit breaker out from the interior of the cabinet but only after the threads of the longitudinal rod are fully disengaged from the stationary nut at the rear of the enclosure. This is generally capable of being done, however, only after the large screw-threaded portion of the rod on the bottom of the switchgear is turned to rack our or remove the switchgear (by manual or drill-bit counter clockwise rotation of the same) from a rearwardly-located stationary nut on the floor of the cabinet. Once the exterior threads of the rod are removed from the internal threads of the nut, the operator can pull the circuit breaker from the cabinet by pulling upon the handle. The wheels will ease the removal of the electrical circuitry and components from the housing or enclosure.

In this connection, Applicant is also the inventor of US Patent No. 11,444,439 issued Sep. 13, 2022; No. 11,799,273 issued Oct. 24, 2023 and US Patent No. 12,085,614 issued Sep. 10, 2024. These relate to switchgear and enclosures and generally show mechanisms for allowing effective and safe racking in and racking out of switchgear/circuit breakers from the cabinets or enclosures without damage to either. So, too, is US Patent 12,255,441 issued Mar. 18, 2025. Those references are expressly incorporated herein by reference and disclose mechanisms for facilitating the racking in, racking out, and movement (by a front located two-piece horizontal handle, for example) of the switchgear/circuit breaker from the enclosure, housing or cabinet. It is this general area of technology that the present invention is directed towards, namely, the provision of switchgear and its associated electrical components, within a cabinet, enclosure or housing, which is rackable into and out of the cabinet, enclosure or housing, when access to the components, especially the rearward located components, is desired. The present invention provides a simple removal mechanism for the switchgear even if the longitudinal threaded screw rod is cross threaded with the rear-located stationary nut.

In actual field use, from time to time, the distal end of the longitudinal screw rod at the bottom of the switchgear or circuit breaker can become cross threaded with the rearwardly and stationary located nut’s threads such that the simple act of removal of the switchgear or circuit breaker from the enclosure or cabinet is difficult and may even require the destruction of the rear vertical wall of the enclosure for gaining access to the rear of the circuit breaker. The present invention is meant to allow for a quick, easy, inexpensive, somewhat fail-proof, minimal number of moving parts, i.e., a mechanism to allow for the simple removal of the switchgear or circuit breaker through the front of the enclosure. This can be accomplished through the front of the cabinet even where the longitudinal screw and its threads do not allow for racking out the switchgear from the stationary nut at the rear and bottom of the enclosure, cabinet or housing.

The present invention is thus directed to large rack in and rack out switchgear or circuit breakers with respect to their housing, cabinet or enclosure. A few mechanical pieces are provided to the manufactured device and when quick and simple removal is desired, the operator, after shutting off current flow and voltage to ensure safety, can use a special set of tools, as described herein, for facilitating removal. This will allow the circuit breaker to be easily removed. These components are described herein as well as the manner of making and using the same.

However, the basic invention comprises a spacer rod rotatively secured between two horizontal, mechanical steel cross members, near floor-located struts of the carriage (or trolley) within the enclosure of the switchgear and held there by a simple mechanical “shark fin” shaped and flat piece of metal , held in place by an Allen head (or similar) screw. The spacer rod extends between the struts and with the shark fin in place, the carriage can not be pulled out when the rod is held in the stationary nut. However, unscrewing that small screw will allow the “shark fin” to be removed (often by a simple gravity fall) from its machined slot in the proximal end of the spacer rod and the spacer rod can then be slid along and over the longitudinal rod to remove the carriage as the spacer rod can slide over the longitudinal rod which is contained therein. Thus, the carriage can be pulled out of the enclosure. After removal of the “shark fin,” the spacer rod is capable of sliding forwardly as the carriage is removed. Stated differently, the spacer rod will no longer hold the carriage from between the struts of the housing, near the floor even when the longitudinal threaded rod is still connected to the stationary nut.

### BRIEF DESCRIPTION OF THE DRAWINGS

FIG. 1 is a top partial plan view of the distal end of the carriage of the switchgear with the longitudinal rod or screw rotatively secured within and to a racking in and racking out medium-sized or circuitry switchgear or device, with the distal tip or end of the screw/rod approaching or about to be captured by a stationary nut (shown on the right side of the Figure) held on the far and bottom end of the floor of an enclosure or cabinet;

FIG. 2 is a top perspective partial view of the distal end of the carriage for the switchgear with a distal and threaded end of a longitudinal rod or screw again proximal or approaching the stationary nut secured to the rear and bottom of the enclosure or cabinet for the switchgear;

FIG. 3 is an exploded view of the longitudinal and threaded rod, rotatively secured to the bottom of the switchgear, with its proximal end, unthreaded, passing through two parallel fixing channels or struts and also showing the proximal head end of the longitudinal rod with a spacer tube rotatively passing over the proximal and preferably non-threaded end of the longitudinal rod;

FIG. 4 is a top plan view of the longitudinal and distal end-threaded rod of the present invention and shows the rotative manner by which the same pass through the fixing channels or struts and also shows the head end (on the right side of the Figure) of the longitudinal rod, when the switchgear is fully racked into the enclosure or cabinet, and shows the components in position prior to any need for quick removal of the switchgear from the enclosure or cabinet;

FIG. 5 is a side view of the longitudinal rod of the present invention as shown in FIG. 4 and shows the rod rotatively secured between the two fixing channels or struts, again, in the position before the need for a quick disconnect and removal of the switchgear from the enclosure, housing or cabinetry;

FIG. 6 is a partially exploded and top plan view of the components of the quick disconnect system of the present invention, with the Allen headed screw and “shark fin” on the head or proximal end (to the left of the Figure) of the longitudinal rod disconnected from the longitudinal rod and shows that the spacer tube can be laterally slid and removed (or moved toward the left side of the Figure) to allow the carriage and switchgear (riding on wheels) to be pulled or racked out of the cabinet by the wheels gliding upon parallel, front to back, tracks for the wheels (or directly upon the floor of the cabinet or housing) – the parallel struts between which the spacer tube extends) are shown in dotted lines extending across the longitudinal rod and spacer tube;

FIG. 7 is a partially exploded and side elevational view of the components of the quick disconnect system of the present invention shown in FIG. 6 (with the struts of the enclosure shown in dotted lines), with the Allen screw and “shark fin” on the head end of the longitudinal rod disconnected from the head end so that the spacer tube can be laterally removed, slid and removed (toward the left side of the Figure) to allow the carriage and switchgear (preferably riding on wheels) to be pulled or racked out of the cabinet, by the wheels gliding upon parallel, front to back, tracks for the wheels (or upon the floor of the cabinet or housing) even though the threaded end of the longitudinal rod is connected (possibly due to cross threading) to the stationary nut at the distal end of the enclosure;

FIG. 8 is an exploded perspective view of the longitudinal rod, with threading on its distal end, a spacer tube sliding and rotative over the proximal end of the longitudinal rod, a shark fin held in opposed, parallel openings in a slot of the proximal end of the longitudinal rod and an Allen screw for securing the shark fin to the proximal end of the longitudinal rod;

FIG. 9 is a cross-sectional view of the proximal end of the longitudinal rod and the shark fin held by an Allen screw in a blind bore located on the proximal end of the rod and captured in threads within the blind bore in the proximal end of the longitudinal rod;

FIG. 10 is a top plan view (with the stationary nut shown on top of the Figure) of the stationary nut secured on the floor of an enclosure, shown with the tip and distal end of the longitudinal rod captured therein with the spacer tube of the rod rotatively held around the proximal end of the longitudinal rod and extending though two parallel, horizontally extending struts of the carriage, with the shark fin held in the proximal end of the longitudinal rod by a small Allen screw;

FIG. 11a is a perspective view of a tool for holding the shark fin secured in the longitudinal rod to provide a known (in the illustration, a horizontal) orientation so that, when the Allen screw holding the fin to the proximal end of the longitudinal rod is unscrewed, the shark fin will, after a rotation to a vertical orientation, easily fall out of the opposed openings of the slot in the end of the longitudinal rod, to the floor, and thus the spacer rod will fall, too, as the carriage for the circuit breaker is drawn out and and removed from the enclosure, as the spacer tube slides over the proximal end of the longitudinal rod, while the carriage is being pulled out of the enclosure, FIG. 11b is a side view of the first T-shaped tool and shows the detail for the distal end which cooperates with the longitudinal rod and the shark fin held thereby;

FIG. 12a is a perspective view of a second tool for facilitating the decoupling of the spacer tube from between the struts of the carriage and allows the Allen screw to be first unscrewed, which allows the shark fin to fall, by gravity, to the floor and then the carriage of the circuit breaker to be pulled outwardly (racking out) from the enclosure in a simple, quick and efficient manner, when and as desired; and FIG. 12b is a side view of the tool shown in FIG. 12a; and

FIG. 13 is an exploded and side elevational view of the longitudinal rod with the spacer tube rotatively seccured thereon and thereover, and shows the manner of securing the first T-shaped tool to the proximal shark fin (in its horizontal orientation) and also shows the second tool which can slide down the barrel of the T-shaped tool such that its distal end can unscrew the Allen nut which secures the shark fin into the proximal end of the longitudinal rod, the unscrewing allowing the shark fin, after the T-shaped tool is rotated to have its top legs vertical, to drop out, by gravity, which thus releases the spacer tube so that the longitudinal rod, even if secured to the stationary nut, nevertheless allows the carriage of the circuit breaker to be pulled out of the enclosure.

### DETAILED DESCRIPTIION OF THE FIGURES, THE PREFERRED EMBODIMENTS AND THE INVENTION

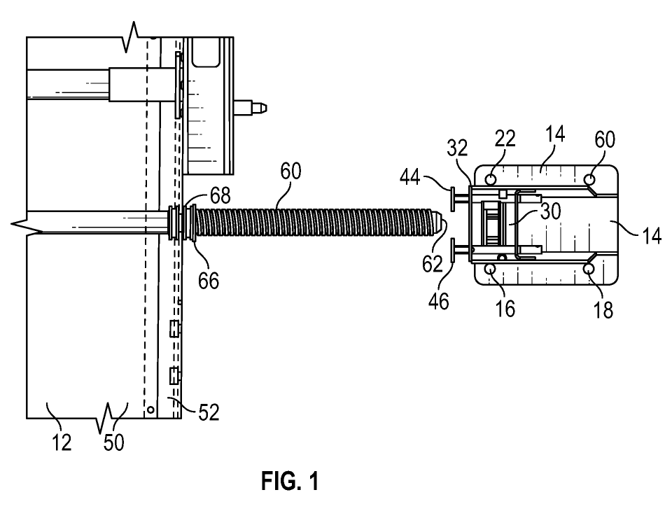

As best seen in FIG. 1, a carriage 12 carrying the bulk of the electrical components of the circuit breaker of a switchgear, is slidable into and out of (rackable into and rackable out of) a cabinet, housing or enclosure. This can be appreciated by one of skill in the art and by a review of the Figures of the above described and issued US patents (in the Description of the Prior Art) which relate to switchgear and/or circuit breakers of the medium voltage kind which are housed in an enclosure or cabinet and have wheels which allow for the gliding in and out of the circuit breaker from the switchgear when desired (maintenance, repair, replacement, etc.). The wheels are rotatively secured to the support carriage and preferably glide upon a pair of parallel rails (or directly upon the floor of the enclosure or cabinet) which are secured to the inside and bottom of the cabinet. Alternatively, the wheels can roll directly upon the inside floor or interior base of the cabinet or housing.

In FIG. 1, the right side shows a stationary nut holding bracket 14, having four holes 16, 18, 20, and 22, securing the bracket 14 to the floor of the cabinet, near to the rear or distal end of the cabinet and on the floor of the cabinet. The stationery nut 30 (with internal screw threads) is held perpendicular to the floor of the housing and is secured within a vertical wall segment 32 of the L-shaped bracket extending upwardly from the base of the bracket, holding the nut near and above the floor. The nut 30 has internal threads and, in this embodiment, there are also shown two outwardly spring biased push buttons 44 and 46, which mechanically cooperate with the function of the nut. These push buttons are spring biased outwardly (forwardly and proximal with respect to the front of the switchgear) and are depressed inwardly when the distal end of the carriage 50 and its rear fixing channel 52 (a horizontal support strut) are driven into the cabinet such that the vertical wall of fixing channel 52 presses against and pushes the push buttons towards the rear of the enclosure. When that happens, the threaded longitudinal rod 60 will begin to freely rotate with the nut and, thus, the carriage will no longer be racked inwardly. This is a different embodiment for the more-forward (proximal) portion of the rod having no screw threads (as shown in the same inventor’s prior now-issued US Patents) and thus that section of the screw rod is in the more recent invention maintained within the nut. A ratchet mechanism (described and shown in US Patent 12,255,441, issued Mar. 18, 2025, to the same inventor herein) illustrates the new and preferred mechanism for ensuring racking in and racking out, as desired, without damage to the mechanism. The ratchet mechanism ensures against over racking in of the carriage with respect to the enclosure. And, the push buttons, when depressed backward/towards the rear of the enclosure, cooperate with other mechanical components to allow the stationary nut to no longer be stationary, rather the nut and end of the rod will freely spin due to the ratcheted mechanism. Rather the nut will then freely spin with the rod and thus no further relative distal longitudinal motion of the longitudinal rod with respect to the stationary nut will occur.

When the outside threads of the longitudinal rod 60 are screwed or turned clockwise with respect to the stationary nut 32, the carriage 50 will rack inwardly so that the components of the switchgear are drawn into the cabinet. When the rod and its screw threads are turned counterclockwise with respect to the internal threads of the nut 32, the carriage 50 and the components of the switchgear or circuit breaker are slowly racked out. This is the basic means and mechanism for racking the carriage in and out of the cabinet. When the leading tip 62 of the threaded end of the longitudinal rod 60 is no longer captured within the internal threads of the nut 32, i.e., it becomes proximal to the stationary nut, the carriage can be pulled manually out of the cabinet. And, as mentioned, when the exterior threaded end of the rod passes fully through the internally threaded nut, i.e., it is distal to the stationary nut, further turning of the longitudinal rod will not result in further racking in of the breaker within the cabinet. That is because of the function of the absence of screw threads at that portion of the rod and/or the ratchet mechanism secured to the stationary nut. Thus, further racking in is also ceased when the carriage strut bears against the push buttons as that activates the ratcheting mechanism which allows for rotation of the longitudinal rod along with rotation of the otherwise stationary nut (i.e., it is no longer held stationary because the mechanism for securing the same in position is released and the nut and the rod simultaneously rotate).

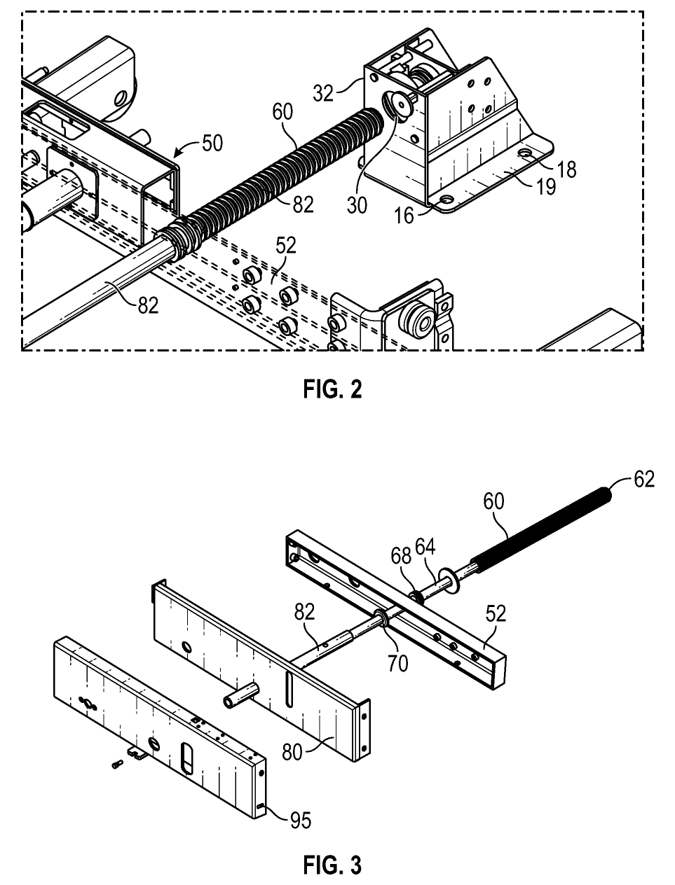

If, however, there is cross threading or another mechanical problem with the removal of the threads of the longitudinal rod from the internal threads of the stationary nut, then the present invention will allow for the quick and easy removal of the carriage from the cabinet. FIG. 2 shows the leading tip of the longitudinal rod as it approaches the stationary nut, held by the bracket to the floor of the enclosure.

As best seen in FIG. 3, the longitudinal rod has a portion of its distal length provided with the exterior screw threads for cooperating with the internal screw threads of the stationary nut. The rest of the rod (the more proximal section) is preferably unthreaded and of smaller outer diameter than the threaded and distal end. The smaller diameter and proximal end 64 is provided with a washer 66, located on the far or distal end of the most distal fixing channel 52. A pair of ball bearing elements 68, 70 are provided about the reduced in diameter end 64 of the longitudinal rod to allow ease of relative rotation of the proximal end of the longitudinal rod 64 within the spacer tube 82 and also within an aligned aperture or hole of the most distal fixing channel 52.

Originally located between fixing channel 52 and the second, relatively proximal fixing channel 80 is the spacer tube 82. With the spacer tube locked in place by the shark fin held in the forward or proximal end of the longitudinal rod, the cross threading of the longitudinal rod in the threads of the stationary nut will maintain and hold the carriage within the enclosure. However, if the shark fin is removed and the spacer tube able to be slid along and off of the longitudinal rod, the entire carriage can be removed from the enclosure.

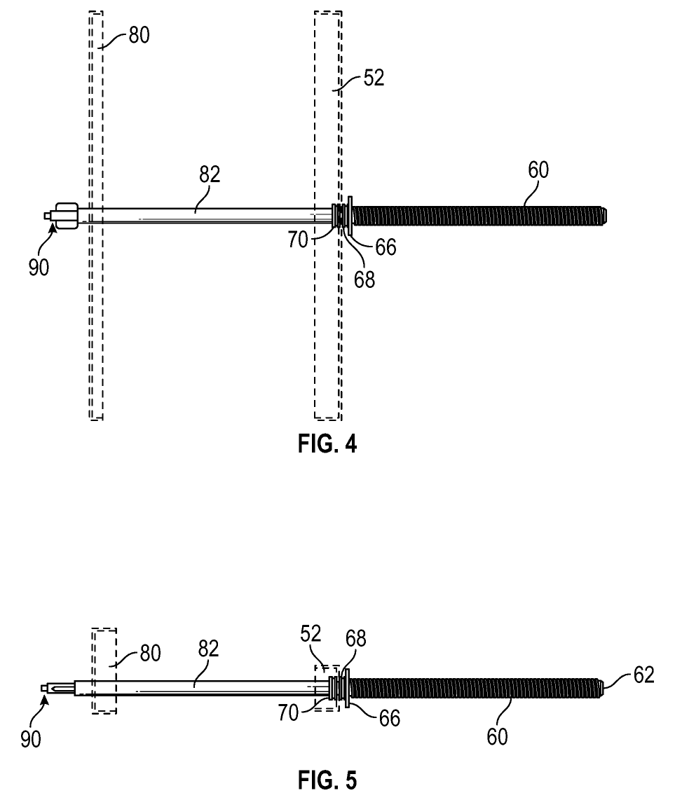

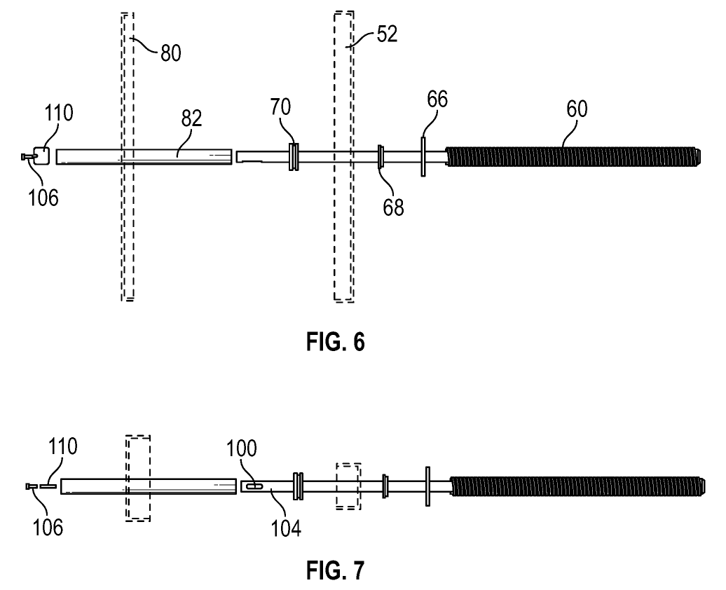

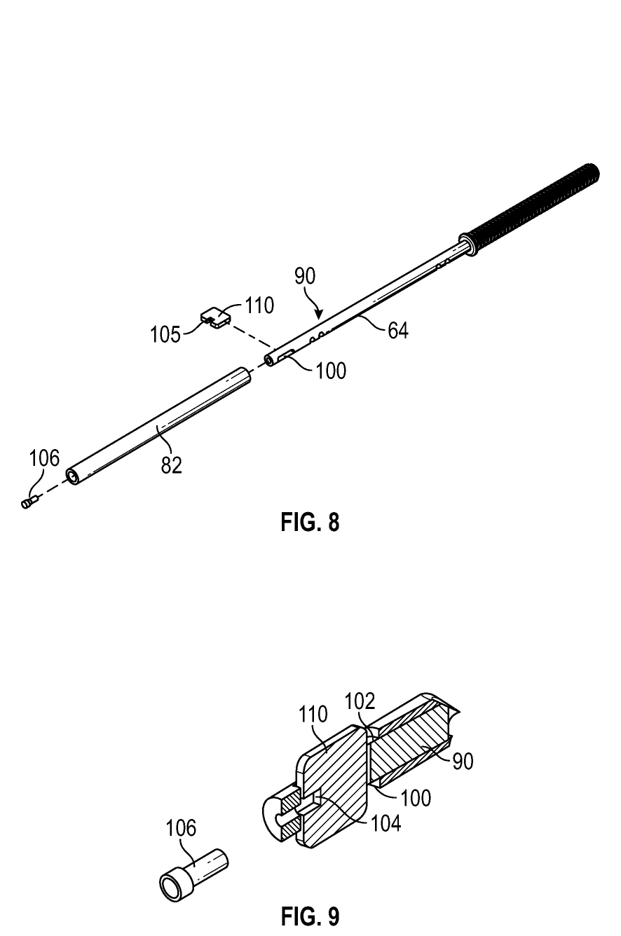

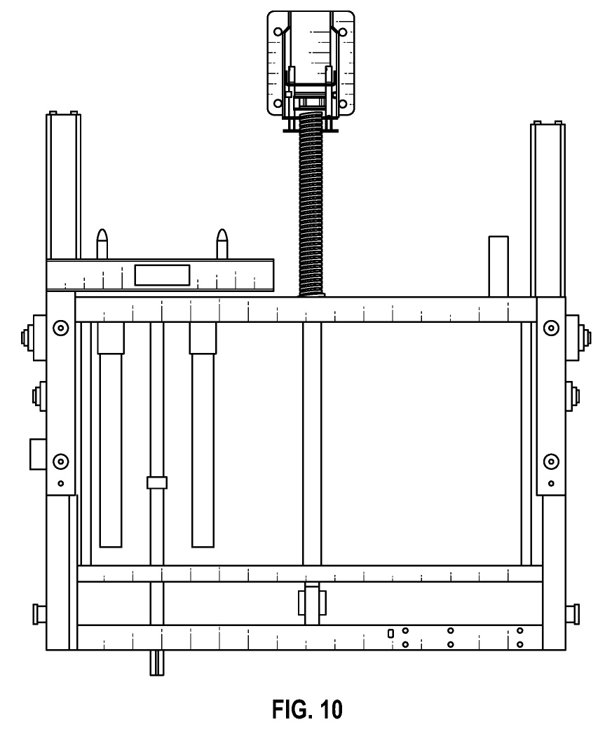

The spacer tube is rotatively secured over the smaller outer diameter and proximal end 64 of the longitudinal rod 60. The spacer tube 82 has a greater inner diameter than the outer diameter of the longitudinal rod, at least at the section of the longitudinal rod over which it freely rotates and is held. The spacer rod freely rotates and extends between the fixing channels 52 and 80. The longitudinal rod 60 proximally extends forwardly and beyond the fixing channel 80 and extends, too, proximally to be through the adjacent and next proximal cross-wise strut or carriage element 95 (See FIGS. 3, 4 and 5). The spacer tube 82 is of about the same length as the distance between the fixing channels 52 and 80. The longitudinal rod 60 extends within the spacer tube and on its far distal end can have its tip 62 of the screw threads captured by the stationary threaded nut and on its proximal end presents a small blind screw bore 104 (see FIG. 9) for the holding Allen screw 106, serving to hold the shark fin 110 within a slot having opposed openings 100 and 102 (see FIGS. 8 and 9).

At the front or proximal end 90 (see FIG. 9) of the longitudinal rod 64 is the pair of opposed side openings 100, 102 (these can be easily seen in FIGS. 8 and 9) defining the slot machined into the end of the longitudinal rod 64. A blind and internally threaded screw bore 104 is located at the proximal end of the longitudinal rod, within the slot and between the opposed side openings 100, 102. That screw bore 104 receives the threads of the Allen screw 106 (i.e., a screw preferably having an Allen head). The screw 106 passes into the end of the longitudinal rod 60 and is insertable into the internal threads of the blind bore so that the Allen screw’s shaft at least partially extends into the rectangular cut out 104 of the shark fin 110. The tip of the Allen screw is held in the blind bore and the shaft holds the shark fin in place. The shark fin fits within the opposed side slots 100 and 102 and is held there when the Allen screw 106 is screwed into the bore 104. When the screw 106 is removed, the shark fin (being a flat piece of metal) will fall by gravity to the ground (it is less in thickness than the opening or width of the opposed side slots 100 and 102) usually when the longitudinal rod is rotated so that the opposed side slots are vertical. Again, the spacer tube freely rotates about the rod 64 and is located between the fixing channels 52 and 80– when the shark fin 110 is secured within the opposed side slots 100, 102 and the screw 106 held within the bore 104 the spacer tube prevents the removal of the carriage from the enclosure but when the shark fin is removed, the spacer tube can slide over the longitudinal rod and the carriage can be easily pulled outwardly from the enclosure.

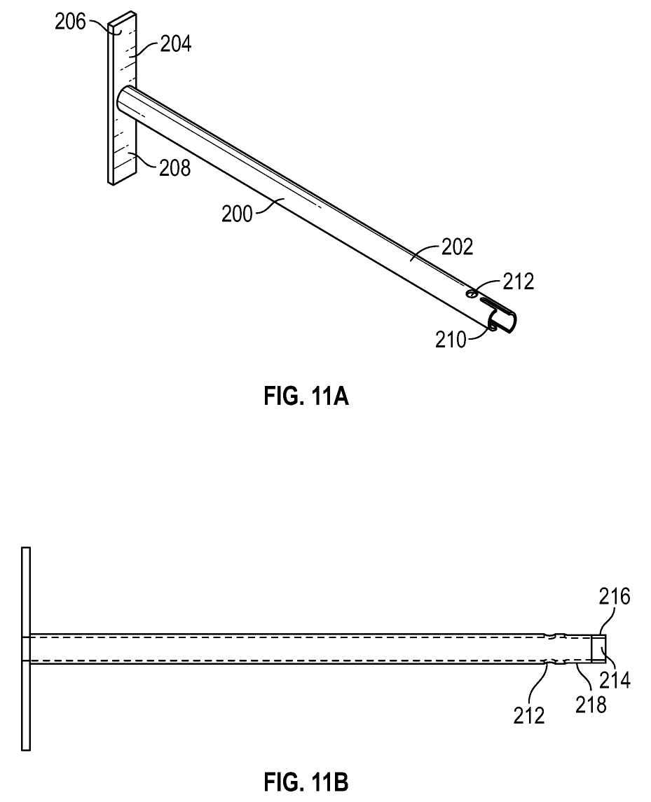

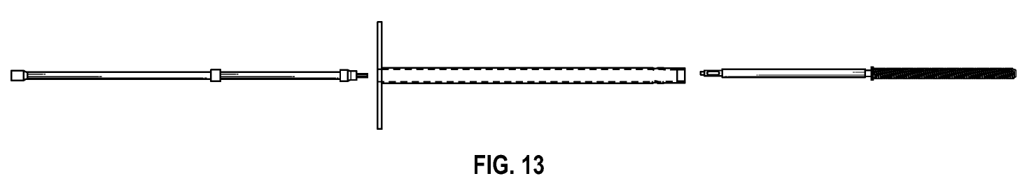

To facilitate the removal (in a quick and easy manner) of the carriage for the circuit breaker from the enclosure, a set of two tools are provided. The first such tool is a T-shaped device 200 as shown in perspective in FIG. 11a. It comprises a hollow tube 202 for a long leg of the T-shaped device and a T-forming top element 204, which is formed from a pair of short top legs 206 and 208. The bore of the longer hollow tube 202 has an opening between the top legs 206 and 208. At the distal end of the long leg 202 is a connector element 210 comprising a visualization aperture 212 and a slot 214 (See FIG. 11b) formed between an extended, curved section 216 and a short and curved lower element 218, as shown in the Figures. The slot is wide enough to slide over the shark fin (or stated differently, the shark fin slides into the slot) when the slot 214 slides over the ears of the shark fin, i.e., when the opposed fins of the shark fin are aligned with the opposed openings of the slot of the connector element 210 (see FIG. 13). As can be seen, the opposed openings defining the slot area aligned with the outward extension of the two short legs so that the orientation of the shark fin, within the openings of the slot, is known by the orientation of the short legs. Stated differently, if the legs extend up and down with respect to the ground, then the shark fin extends up and down so that if and when the Allen screw is removed from holding the shark fin, with the legs of the T-shaped tool exending up and down, the shark fin will a) extend up and down, too, and thus, with the Allen screw removed, the shark fin can fall to the ground by gravity.

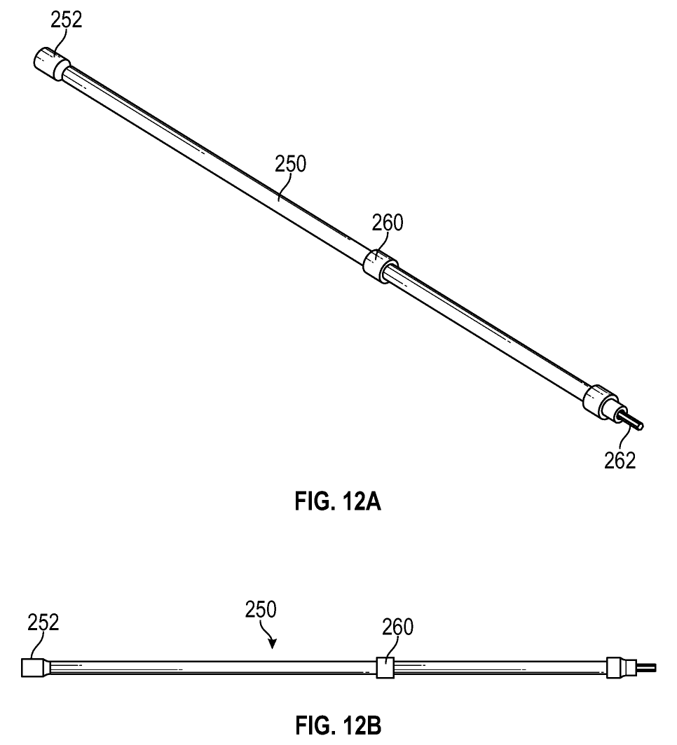

The second tool element 250 (shown in FIGS. 12a and 12b comprises a drive socket extension element 252 with a female connection for a drill bit to rotatively turn the drive socket extension with an electric or manual drill. The drive socket extension element 252 is long enough so that it slides down and within the T-shaped tool and can rotate within the hollow tube of the T-shaped tool 200 with the distal end of the drive socket extension element coming into contact with the head of the Allen screw 106. A bushing 260 can be provided along the length of the drive socket extension element 250 to facilitate the reduction in the friction between the turning of the drive socket extension element and the inside cylindrical wall of the hollow tube 202 of the T-shaped tool 200 and to perfectly center the shaft 250 within the tube# 202 so that the Allen screw tool turning head will perfectly align with the head of the Allen screw and seat itself within that screw head easily. At the distal end of the drive socket extension element 252 is a drive bit 262 which matches the shape and size of the head of the Allen screw 106 so that turning the drive socket extension element 252 in a counterclockwise direction will unscrew the Allen screw 106 and that will allow the shark fin to fall (when the fin is moved into a vertical position) which will then allow the spacer tube to slide off of the longitudinal rod so that the carriage can be removed, even though the longitudinal rod is still connected at its distal end to the stationary nut.

In the event that the removal of the circuit breaker is desired from the enclosure and a mere counterclockwise turning of the longitudinal rod will not disengage the same from the stationary nut, the present invention allows for the easy, quick and safe removal. The operator can use the tools of the present invention and accomplish the sliding out of the carriage. This entails first shutting off power, for safety. Then, using the first T-shaped tool. The T-shaped tool will be pushed (see FIG. 13) so that its connecting distal end mates with the shark fin of the longitudinal rod. This is made easier by the short legs of the T-shaped tool being held side to side with respect to a floor or level surface. The connecting end of the T-shaped tool can be pushed and slightly rotated if necessary by using the short legs so that the tool engages the shark fin. A slight “give” will be sensed as the connecting end is first pushed inwardly, then the T-shaped tool slightly rotated, until the “give” is sensed and the operator thus knows that the tool is connected over and to the shark fin. The T-shaped tool is then rotated a quarter turn so that the short legs are held “up and down” and that corresponds to the shark fin being in a vertical orientation. Then the second tool is inserted into the hollow tube of the T-shaped tool, with its drive bit 262 being slid into and through the tube 202 of the T-shaped tool. The length of the second tool is sufficient to allow the end 252 of the second tool to be accessed by a drill, a ratcheting drive tool or other mechanism while the front or distal end with the hex bit socket 262 will be connected and capable of driving counterclockwise (rotating) the Allen screw 106.

Counterclockwise rotation of the second tool will loosen and remove the Allen screw 106 from the bore 104 and when the Allen screw is removed from the bore, the shark fin will (by gravity) fall to the floor. The operator will either feel the shark fin’s removal or hear a slight metallic sound of the shark fin falling to the floor. With the shark fin removed from the longitudinal rod, the operator can first remove the second tool and then simply pull on the handle of the circuit breaker and remove the same from the enclosure (that handle is fully described in the prior art patent of mine, as described above). This removal is allowed by the carriage, with the spacer rod, gliding over the longitudinal rod, which was otherwise prevented when the shark fin was still connected to the end of the longitudinal rod. In this manner, the circuit breaker can be removed, easily, quickly, efficiently, and safely even if the distal end of the longitudinal rod of the circuit breaker is still connected or cross threaded to the stationary nut. The present invention allows for the easy, quick, safe and efficient removal.

When desirable reassembly is required, after repair, maintenance or substitution of the circuit breaker, the spacer tube is first slid over the longitudinal rod, held between the struts of the carriage, then the shark fin is placed into the slot of the longitudinal rod, preferably with the shark fin extending cross wise, and the Allen screw re-secured. The circuit breaker component of the switchgear can then be pushed towards and into the enclosure and the proximal end of the longitudinal rod can be rotated so that the leading tip, threaded at its distal end, will engage the stationary nut and further rotation of the longitudinal rod, in the clockwise direction, will draw the circuit breaker into the enclosure. The spacer tube will be ready, with the shark fin secured for use, if and when necessary for a quick, safe and efficient removal, if needed.

When that operation is completed, the distal end of the longitudinal rod will be captured within the stationary nut of the bracket on the floor of the enclosure. This will correspond to the switchgear being racked into the enclosure. The racking in is not hampered by the spacer tube as the smaller diameter of the longitudinal rod within the spacer tube will easily rotate for the racking in process. However, when a quick disconnect is desired, the present invention will allow the racking out of the switchgear in a minimum of time and without disengaging the external screw threads of the longitudinal rod from the internal threads of the stationary nut. Again, if desired, to quickly and easily remove the carriage of the switchgear, after shutting “off” the voltage and current, the operator can use a simple Allen ratchet wrench on the front or end of the second tool, passing it first through the bore of the first T-shaped tool until it comes into play with the Allen screw holding the shark fin to the proximal end of the longitudinal rod. The male bit of the second tool will unscrew the Allen screw.

If the length and distance from the front panel of the switchgear to the Allen screw is too long for a conventional Allen ratchet wrench, a simple rod-like extension member or second tool 250 can be used to have its male end cooperate with the head of the Allen screw 106. The screw can then be removed. If the shark fin does not quickly drop out of the opposed slots 100, 102, a slight further turning of the screw or the end of the longitudinal rod ought to loosen the shark fin for dropping out due to simple gravity can be effective. With the spacer tube no longer secured or held between the two fixing channels, the carriage can be simply pulled out of the enclosure. Again, if the spacer tube were secured by the shark fin between the two fixing channels, the removal of the carriage would be blocked by the shark fin held in the opposed openings of the slot of the proximal end of the longitudinal rod. However, as mentioned, if the shark fin is removed, the carriage can be pulled outward even though the distal and threaded end of the longitudinal rod is still secured to the stationary nut. The spacer tube allows for ease of removal of the carriage from the enclosure as the spacer tube easily slides forwardly within the aligned apertures of the fixing channels, once the shark fin has been first removed.

To restate use of the present invention, when an operator needs or wants to quickly rack out or remove the carriage from the cabinet, he can try first to unscrew the longitudinal rod so that its distal and threaded end disengages from the stationary nut and then pull the carriage out. However, now, alternatively, if that is not successful in removing the circuit breaker component from the enclosure, the operator can use the specially designed T-shaped tool (see FIGS. 11a and 11b) with a long shafted ratchet wrench (see FIGS. 12a, 12b and 13) to unscrew the Allen screw 106 and remove the shark fin 110. The legs or short ends of the top of the T-shaped tool will correspond and “tell” the operator that the shark fins are vertical when the tool is vertical and this will facilitate the removal of the shark fin from the opposed openings 100 and 102 of the slot. With the T-shaped tool placed so that it is longitudinally aligned with the longitudinal rod, the short ends of the top of the Tof the tool can be placed, one leg above the other and that corresponds to the shark fin being held up and down so that a quarter rotation of the T will place the short legs up and down and that means that the shark fin is extending upwardly and downwardly. This position will ensure that the shark fin is perpendicular to the floor and the opposed openings of the slot in the longitudinal rod, holding the shark fin, are one above the other so that when the Allen screw is unscrewed from the rectangular slot 104 of the shark fin, the shark fin, by gravity, will fall out, allowing then for the operator to pull upon and remove the carriage from the enclosure.

When the screw is removed, the shark fin 100 can be easily slid downwardly out of the opposed openings defining the slot 100. This then allows the carriage to be moved out of the cabinet or housing as the shark fin was the holder of the spacer tube between the fixing channels. With the spacer tube no longer secured between the fixing channels, the carriage can be withdrawn and the spacer tube either slides out of the front hole within a strut of the carriage or simply falls to the ground/floor of the cabinet when it clears the end of the longitudinal rod. In any event, the spacer tube is no longer holding the carriage between the fixing channels and the carriage is free to be removed from the enclosure or cabinet.

Of course, the carriage and switchgear can be reassembled or placed back into the cabinet, too. Here, the user/operator can first slide or move the carriage inwardly until it has the threaded distal portion of the longitudinal rod close to the stationary nut; then slide the spacer tube in and over the preferably non-threaded portion of the rod, and then place the shark fin between the opposed opening of the slot and secure it in place by re-screwing the Allen screw. This will secure the spacer tube on and over the longitudinal rod. Then the carriage can be racked in by further turning of the longitudinal rod with its screw threads drawing the carriage and circuit breaker into the enclosure as the distal threads or the rod interact with the stationary nut of the floor of the housing or enclosure or cabinet.

I claim:

1. A switchgear removal mechanism for the quick removal of a circuit breaker on a carriage from its enclosure having a pair of opposed and substantially parallel fixing channels extending across the direction of movement of the circuit breaker for racking the same into and out of the enclosure comprising:
a) at least a partially threaded distal portion of a longitudinal rod rotatively secured to said carriage and extending from the proximal toward the distal end of the enclosure, said rod’s threaded distal portion being securable into a stationary nut secured to said enclosure, such that rotating said rod in a first direction racks the carriage into said enclosure;
b) a spacer tube secured over and rotative around said longitudinal rod and extending substantially between said fixing channels;
c) a mechanical fastener element securable yet removable to the proximal end of said longitudinal rod for ensuring that said spacer tube is laterally positioned between said fixing channels when said mechanical fastener is engaged with said longitudinal rod; and
d) a tool for removing said mechanical fastener element from said longitudinal rod to allow said spacer tube to be slid over one end of said longitudinal rod and to allow for removal of the carriage as the spacer tube is no longer held between said fixing channels, to selectively remove said circuit breaker on said carriage from said housing.

2. A mechanism as claimed in claim 1 wherein said mechanical fastener element comprises a flat shark fin-like piece held in an end of said longitudinal rod and extending beyond the outer circumference of said longitudinal rod by a screw held within a blind bore on one end of said longitudinal rod.

3. A mechanism as claimed in claim 2 wherein said flat shark fin-like piece is held to said longitudinal rod between a pair of opposed openings defining a slot at the proximal end of said longitudinal rod.

4. A mechanism as claimed in claim 2 wherein said spacer tube is freely rotatively secured over said longitudinal rod when said shark fin-like piece is secured to said longitudinal rod.

5. A mechanism as claimed in claim 4 wherein said spacer tube is of a length of about the distance between said fixing channels of said carriage.

6. A mechanism as claimed in claim 1 further comprising one or more sets of ball bearings for facilitating the rotation of said longitudinal rod within one or more openings of said fixing channels.

7. A mechanism as claimed in claim 1 wherein said spacer tube rotates over said threaded rod by being supported by at least a single set of ball bearings.

8. A mechanism as claimed in claim 1 wherein said tool comprises a T-shaped tool having a hollow tube for its long leg and at the end of said hollow tube having a mechanical connection for engaging said mechanical fastener for facilitating selective removal of the same from said longitudinal rod.

9. A mechanism as claimed in claim 8 further comprising a drive socket extension tool which is rotatable within said hollow tube with one end of said drive socket extension connected to said mechanical fastener.

10. A mechanism as claimed in claim 1 wherein said mechanical fastener comprises a flat, shark-fin element which secures said spacer tube upon said longitudinal rod.

11. A mechanism as claimed in claim 10 wherein said shark-fin like element is secured to the end of said longitudinal rod by a screw having a head that accepts an alignment type tool for engaging and turning.

12. A mechanism as claimed in claim 8 wherein said T-shaped tool has its shorter legs aligned with a pair of opposed openings defining a slot for securing therein a flat, shark-fin element which secures said spacer tube upon said longitudinal rod.

13. A mechanism as claimed in claim 12, wherein said shark-fin element is secured to the end of said longitudinal rod by a screw.

14. A mechanism as claimed in claim 13 wherein said screw is turnable by a tool which extends down the length of a hollow bore of said T-shaped tool having a screw-turning head at its distal end.
